(19) United States
(12) Patent Application Publication
(10) Pub. No.: US 2026/0187809 A1
(43) Pub. Date: Jul. 2, 2026

(54) POSTURE ESTIMATION SYSTEM AND METHOD THEREOF

(71) Applicant: Industrial Technology Research Institute, Hsinchu (TW)

(72) Inventors: Hong-Dun Lin, Hsinchu City (TW); Tai-Wei Su, Taoyuan City (TW); Ren-De Xie, Hsinchu County (TW); BoYang Chen, New Taipei City (TW); Wei-Chun Wang, Taipei City (TW)

(73) Assignee: Industrial Technology Research Institute, Hsinchu (TW)

(21) Appl. No.: 19/230,090

(22) Filed: Jun. 6, 2025

Related U.S. Application Data
(60) Provisional application No. 63/739,092, filed on Dec. 26, 2024.

(30) Foreign Application Priority Data
Mar. 28, 2025 (TW) 114112076

(51) Int. Cl. G06T 7/11; G01S 13/89; G06T 7/70; G06V 40/10

(52) U.S. Cl. CPC G06T 7/11; G01S 13/89; G06T 7/70; G06V 40/103; G06T 2207/10028; G06T 2207/20132

(57) ABSTRACT

Provided are a posture estimation system and a method thereof. The system includes a millimeter wave radar, a camera, and a processing device. The millimeter wave radar is configured to obtain point cloud information including a user. The camera is configured to capture images of a physical scene to obtain image information including the user. The processing device is connected to the millimeter wave radar and the camera to obtain the point cloud information and the image information from the millimeter wave radar and the camera respectively. The processing device is configured to perform point cloud information pre-processing on the point cloud information, perform image information pre-processing on the image information, and obtain a position of each key point of a human skeleton of the user through a posture estimation model.

### CROSS-REFERENCE TO RELATED APPLICATION

This application claims the priority benefit of U.S. provisional application Ser. No. 63/739,092, filed on Dec. 26, 2024 and Taiwan application serial no. 114112076, filed on Mar. 28, 2025. The entirety of each of the above-mentioned patent applications is hereby incorporated by reference herein and made a part of this specification.

### TECHNICAL FIELD

The disclosure relates to motion posture analysis, and particularly relates to a posture estimation system and a method thereof.

### BACKGROUND

In recent years, computer vision has become a key technology in sports, with numerous related applications emerging in this field. However, the commonly used visible spectrum still has room for improvement. For instance, the visible spectrum may be easily affected by the limbs of the user or the environment, such as equipment occlusion, leading to skeleton occlusion and impacting motion posture analysis.

### SUMMARY

The disclosure provides a posture estimation system and a method thereof that utilize five-dimensional point cloud information obtained by millimeter wave radar and 2D image information captured by a camera to obtain a position of each key point of a human skeleton of the user through model inference, thereby improving the accuracy of posture estimation.

A posture estimation system of the disclosure includes a millimeter wave radar, a camera, and a processing device. In an embodiment, the millimeter wave radar is configured to obtain point cloud information including a user. The camera is configured to capture images of a physical scene to obtain image information including the user. The processing device is connected to the millimeter wave radar and the camera to obtain the point cloud information and the image information from the millimeter wave radar and the camera respectively. The processing device is configured to perform point cloud information pre-processing on the point cloud information, perform image information pre-processing on the image information, and obtain a position of each key point of a human skeleton of the user through a posture estimation model.

A posture estimation method of the disclosure includes the following steps. Point cloud information including a user is obtained by a millimeter wave radar. Images of a physical scene are captured by a camera to obtain image information including the user. The point cloud information and the image information are obtained from the millimeter wave radar and the camera respectively. Point cloud information pre-processing is performing on the point cloud information, image information pre-processing is performing on the image information, and a position of each key point of a human skeleton of the user is obtained through a posture estimation model.

Based on the above, the disclosure provides a posture estimation system and a method thereof that utilize five-dimensional point cloud information obtained by millimeter wave radar to compensate for 2D image information captured by a camera in low-light environments or occlusion situations. Also, through synchronizing the point cloud information with the image information and using Long Short-Term Memory (LSTM) and Transformer model, spatial and temporal relationships of the respective key points are obtained. Then, the posture estimation model is utilized to infer and obtain the position of each key point of the human skeleton of the user, thereby improving the accuracy of posture estimation.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic diagram of a posture estimation system according to an embodiment of the disclosure.

FIG. 2 is a flowchart of a posture estimation method according to an embodiment of the disclosure.

FIG. 3 is a schematic diagram of a detailed structure of the posture estimation system according to another embodiment of the disclosure.

FIG. 4 is a schematic diagram of time alignment of point cloud information and image information according to a first embodiment of the disclosure.

FIG. 5 is a schematic diagram of time alignment of the point cloud information and the image information according to a second embodiment of the disclosure.

FIG. 6 is a schematic diagram of cropping a human region from the image information according to an embodiment of the disclosure.

FIG. 7 is a schematic diagram of identifying each key point of a human skeleton in the human region according to an embodiment of the disclosure.

FIG. 8 is a schematic diagram of model inference according to an embodiment of the disclosure.

### DETAILED DESCRIPTION OF DISCLOSED EMBODIMENTS

Some exemplary embodiments of the disclosure will now be described in detail with reference to the accompanying drawings. In the following description, when the same reference numerals appear in different drawings, the reference numerals will be regarded as the same or similar components. The exemplary embodiments are merely a part of the disclosure and do not disclose all possible implementations of the disclosure. More precisely, the exemplary embodiments are merely examples of the methods, devices, and systems in the appended claims of the disclosure.

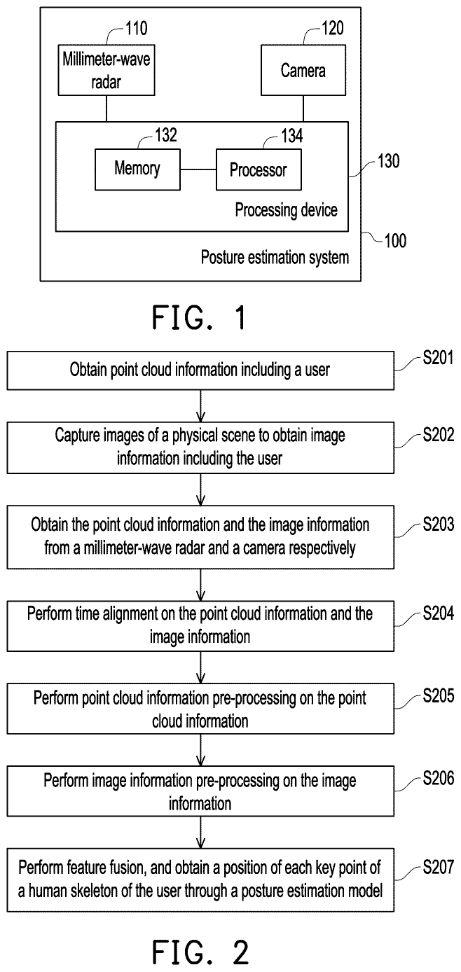

FIG. 1 is a schematic diagram of a posture estimation system according to an embodiment of the disclosure. First, FIG. 1 introduces various components in the system and configuration relationships thereof. The detailed functions will be disclosed together with the schematic diagrams of subsequent exemplary embodiments.

Referring to FIG. 1, a posture estimation system 100 includes a millimeter wave radar 110, a camera 120, and a processing device 130, in which the processing device 130 may be wirelessly, wiredly, or electrically connected to the millimeter wave radar 110 and the camera 120.

The millimeter wave radar 110 is a radar operating in the millimeter wave band, which may calculate the relative velocity, distance, and angle with the target by transmitting millimeter waves through antennas and receiving signals reflected back from obstacles. In other words, point cloud information including a user obtained by the millimeter wave radar 110 may include three-dimensional coordinate information (X coordinate, Y coordinate, and Z coordinate), the velocity (Doppler) of the user relative to the millimeter wave radar 110, and the distance (range) between the user and the millimeter wave radar 110.

The camera 120 may use a standard camera (RGB camera) or other similar components. The RGB camera can provide high-resolution images, which means the camera 120 may have the function of capturing images. The camera 120 is configured to capture images, which is, for example, a camera lens with a lens element and a photosensitive component. The photosensitive component is configured to sense the intensity of light entering the lens element, thereby generating an image. The photosensitive component may be, for example, a charge coupled device (CCD), a complementary metal-oxide semiconductor (CMOS) component, or other similar components.

The processing device 130 is configured to process the point cloud information obtained by the millimeter wave radar 110 and the image information captured by the camera 120 to execute the processes in multiple exemplary embodiments of this disclosure. The processing device 130 includes a memory 132 and a processor 134. The memory 132 may be, for example, any type of fixed or removable random access memory (RAM), read-only memory (ROM), flash memory, hard disk, or other similar devices, integrated circuits, or combinations thereof. The processor 134 may be, for example, a central processing unit (CPU), an application processor (AP), or other programmable general-purpose or special-purpose microprocessors, a digital signal processor (DSP), an image signal processor (ISP), a graphics processing unit (GPU), or other similar devices, integrated circuits, or combinations thereof.

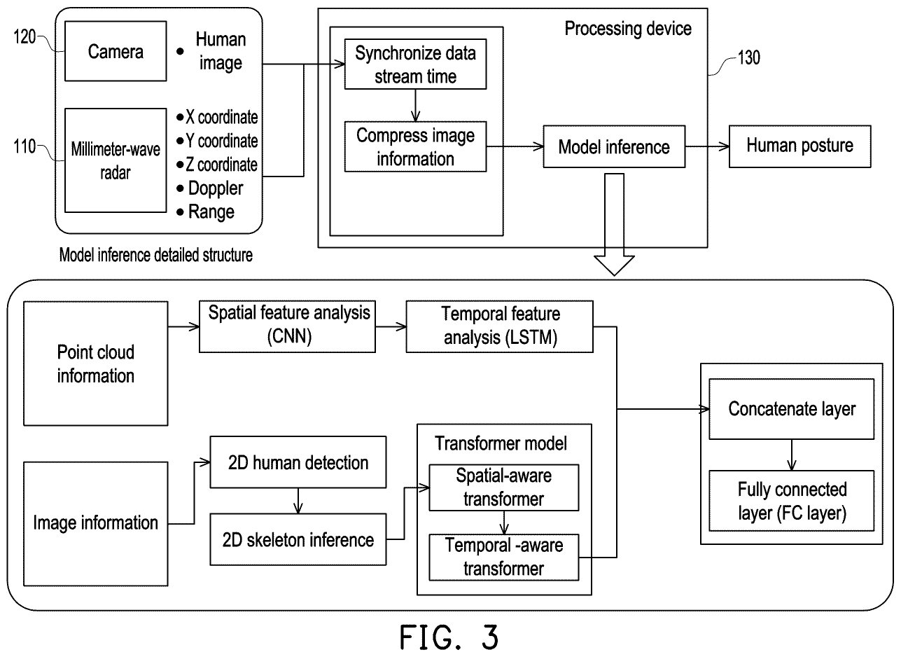

FIG. 2 is a flowchart of a posture estimation method according to an embodiment of the disclosure, and FIG. 3 is a schematic diagram of a detailed structure of the posture estimation system according to another embodiment of the disclosure. The method process in FIG. 2 may be implemented by the posture estimation system 100 in FIG. 3.

Referring to both FIG. 2 and FIG. 3, in Step S201, the millimeter wave radar 110 obtains the point cloud information including the user. The point cloud information may include the three-dimensional coordinate information (the X coordinate, the Y coordinate, and the Z coordinate), Doppler, and range.

In an exemplary embodiment, each parameter of the millimeter wave radar 110 may be set as follows to obtain the point cloud information including the user. For example, an initial frequency is set to 60 GHz, a bandwidth is 4 GHz, a sampling frequency is 15 Hz, a range resolution is 4.69 cm, a maximum detection velocity is 5.69 m/s, a velocity resolution is 0.72 m/s, an angle resolution is 9.55, and an upper limit of point cloud detection is 256. That is to say, the millimeter wave radar 110 extracts multiple frames of point cloud information from the physical scene at the sampling frequency of 15 Hz, and each frame of point cloud information obtained includes 256 points. The disclosure is not limited thereto.

In Step S202, the camera 120 captures images of the physical scene to obtain image information including the user. In this embodiment, the camera 120 is a single-view camera, and the image information captured is a single-view image, with a sampling frequency of 30 Hz, that is, the number of frames captured per second is 30. In other words, the camera 120 captures multiple frames of single-view images including the user from the physical scene at the sampling frequency of 30 Hz.

In Step S203, the processing device 130 obtains the point cloud information and the image information from the millimeter wave radar 110 and the camera 120 respectively.

In Step S204, the processing device 130 performs time alignment on the point cloud information and the image information.

Since the sampling frequency (15 Hz) of the millimeter wave radar 110 is different from the sampling frequency (30 Hz) of the camera 120, the point cloud information obtained by the millimeter wave radar 110 cannot be aligned frame by frame with the image information captured by the camera 120 to ensure that synchronization of the point cloud information and the image information in time may improve the accuracy of posture estimation. Therefore, after obtaining the point cloud information and the image information, the processing device 130 needs to perform time alignment on the point cloud information and the image information.

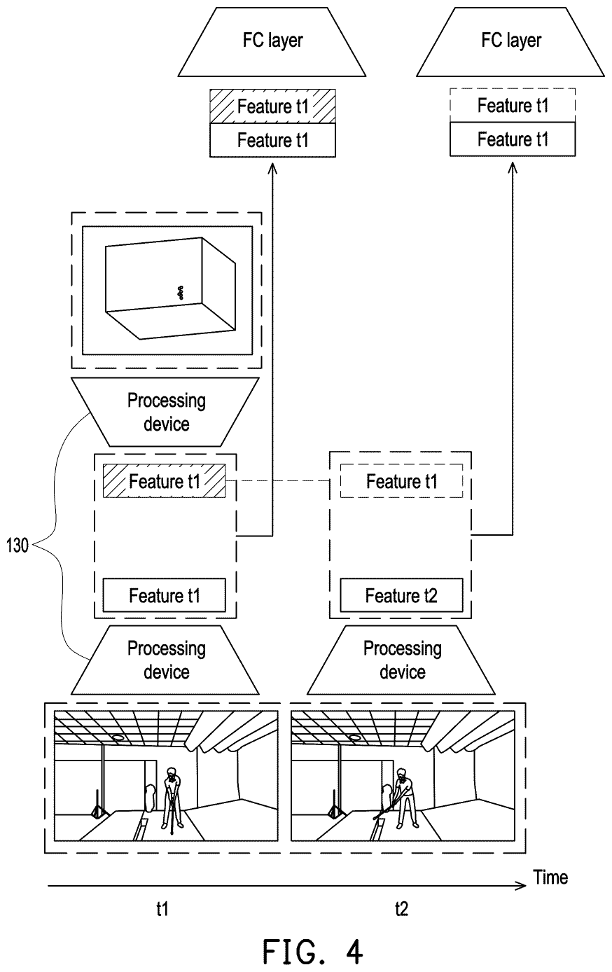

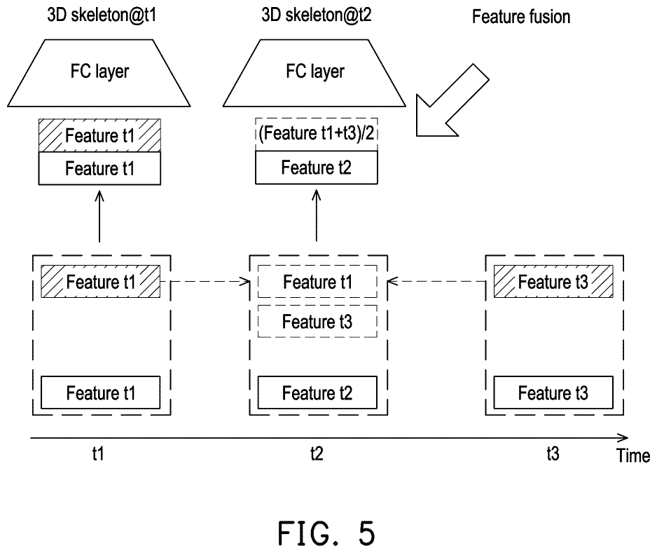

The following exemplary embodiments will specifically explain the time alignment of the point cloud information and the image information in conjunction with the posture estimation system 100 and different application scenarios in FIG. 4 and FIG. 5.

FIG. 4 is a schematic diagram of time alignment of the point cloud information and the image information according to a first embodiment of the disclosure.

First exemplary embodiment is explained using the Delay mode as an example. The millimeter wave radar 110 obtains current point cloud information at a current time point, and the camera 120 obtains current image information at the current time point. If the current point cloud information is lost, then the processing device 130 uses historical point cloud information at a closest time point adjacent to the current time point to serve as the current point cloud information to perform time alignment with the current image information, so as to facilitate subsequent point cloud information pre-processing, image information pre-processing, and feature fusion operations.

In conjunction with FIG. 4, the current time point is t2, the millimeter wave radar 110 obtains the current point cloud information at the current time point (t2), and the camera 120 obtains the current image information (Feature t2) at the current time point (t2). If the current point cloud information is lost, then the processing device 130 uses the historical point cloud information (Feature t1 shown in the hatched portion in FIG. 4) at the closest time point (t1) adjacent to the current time point (t2) to serve as the current point cloud information to perform time alignment with the current image information, and perform the subsequent point cloud information pre-processing, image information pre-processing, and feature fusion operations.

FIG. 5 is a schematic diagram of time alignment of point cloud information and image information according to a second embodiment of the disclosure.

Second exemplary embodiment is explained using the Fusion mode as an example. The millimeter wave radar 110 obtains the current point cloud information at the current time point, and the camera 120 obtains the current image information at the current time point.

If the current point cloud information at the current time point (t2) is lost, then the processing device 130 averages point cloud information at a previous time point (t1) adjacent to the current time point (t2) and point cloud information at a next time point (t3) adjacent to the current time point (t2) to serve as the current point cloud information to perform time alignment with the current image information, so as to facilitate the subsequent point cloud information pre-processing, image information pre-processing, and feature fusion operations.

In conjunction with FIG. 5, the millimeter wave radar 110 obtains the current point cloud information at the current time point (t2), and the camera 120 obtains the current image information (Feature t2) at the current time point (t2). If the current point cloud information at the current time point (t2) is lost, then the processing device 130 averages the point cloud information (Feature t1 shown in the hatched portion in FIG. 5) at the previous time point (t1) adjacent to the current time point (t2) and the point cloud information (Feature t3 shown in the hatched portion in FIG. 5) at the next time point (t3) adjacent to the current time point (t2) (that is, (Feature t1+t3)/2) to serve as the current point cloud information to perform time alignment with the current image information, so as to facilitate the subsequent point cloud information pre-processing, image information pre-processing, and feature fusion operations.

In other exemplary embodiments, the processing device 130 may add timestamps to the point cloud information obtained by the millimeter wave radar 110 and the image information obtained by the camera 120, and use linear interpolation to perform time alignment. The disclosure is not limited thereto.

After time alignment is performed on the point cloud information and the image information (that is, data stream time synchronized), the processing device 130 may compress the image information, so as to reduce unnecessary background image information, such as information other than the human and improve computational efficiency, and then subsequent model inference operations are performed.

In Step S205, the processing device 130 performs point cloud information pre-processing on the point cloud information.

First, the processing device 130 may perform matrix conversion on the point cloud information to obtain a point cloud matrix. In this embodiment, the processing device 130 may convert the point cloud information of the frame containing 256 points with five-dimensional information into a 16×16×5 point cloud matrix. If the frame has fewer than 256 points, zeros are padded to ensure the consistency of the overall data.

Next, the processing device 130 may perform spatial feature analysis based on convolutional neural network (CNN) and perform convolution operations on values in the point cloud matrix, and obtain spatial feature information (that is, three-dimensional spatial feature information) of each key point.

Afterward, the processing device 130 may input the spatial feature information of each key point into Long Short-Term Memory (LSTM) to perform temporal feature analysis to obtain temporal feature information of each key point.

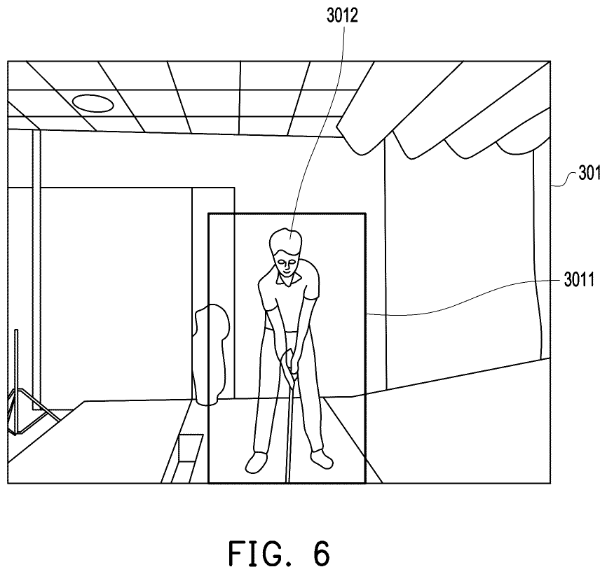

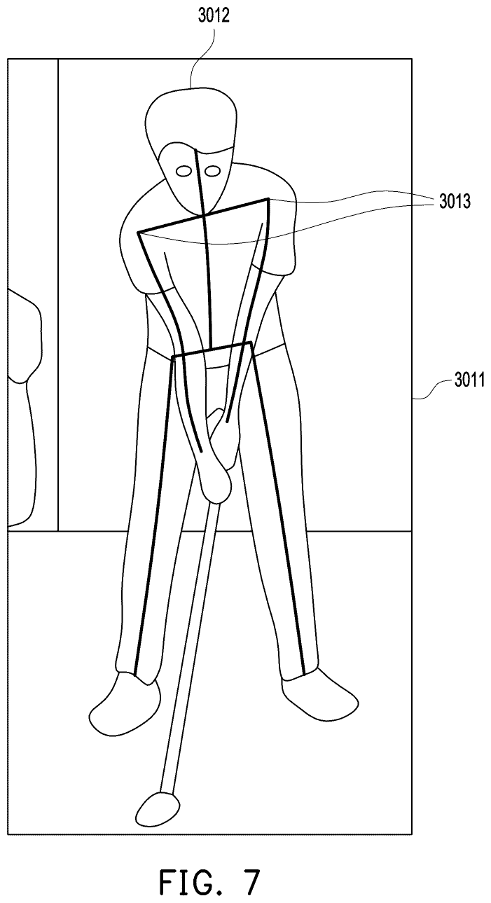

The following description will explain performing pre-processing on the image information in conjunction with FIG. 6 and FIG. 7.

FIG. 6 is a schematic diagram of cropping a human region from image information according to an embodiment of the disclosure. FIG. 7 is a schematic diagram of identifying each key point of a human skeleton in the human region according to an embodiment of the disclosure.

Referring to FIG. 6 and FIG. 7, in Step S206, the processing device 130 performs image information pre-processing on the image information. First, the processing device 130 may perform 2D human detection on image information 301 obtained by the camera 120 based on a human detection model, and crop a human region 3011 including a user 3012 from the image information 301, so as to reduce unnecessary background image information, such as information other than the human, effectively reducing the computational load and improving the accuracy of subsequent posture estimation.

Next, the processing device 130 may use a skeleton estimation model such as High-Resolution Net (HRNet) to perform 2D skeleton inference, to identify each key point 3013 of the 2D human skeleton of the user 3012 in the human region 3011, and obtain two-dimensional coordinate information of each key point 3013.

Afterward, the processing device 130 may, according to the coordinate information of each key point 3013 and using the Self-Attention mechanism of the Transformer model, generate and obtain feature vectors of each key point 3013 at each time point according to the two-dimensional coordinate information and time information of each key point 3013.

In an exemplary embodiment, the Transformer model may learn or obtain the correlation relationship of the same key point at different time points in the time dimension, and learn or obtain the correlation relationship between different key points in the spatial dimension, thereby obtaining the time variation pattern of each key point.

In an exemplary embodiment, the key points 3013 are, for example, joint points or feature points of the human body that are relatively sensitive to changes over time. The joint points of the human body include, for example, elbow joints, shoulder joints, and knee joints. The disclosure is not limited thereto.

In Step S207, the processing device 130 performs feature fusion of the spatial feature information, temporal feature information, and feature vectors of each key point at each time point, and obtain the position of each key point of the human skeleton of the user through a posture estimation model.

Specifically, the processing device 130 may, based on the Transformer model (which may include a Spatial-aware transformer and a Temporal-aware transformer), perform feature fusion of the spatial feature information, temporal feature information of each key point and feature vectors of each key point at each time point, and after feature concatenation through a concatenate layer and model inference through a fully connected layer (FC layer), obtain the position of each key point of the human skeleton of the user.

In an exemplary embodiment, the processing device 130 may extract the relative spatial relationship between each key point of the human skeleton through the Spatial-aware transformer, that is, perform feature fusion of the spatial feature information of each key point in terms of spatial relationship, and through the Temporal-aware transformer, perform feature fusion of the temporal feature information of the same key point and feature vectors at different time points, that is, perform feature fusion on the same key point in terms of temporal and spatial relationships, thereby establishing and training the posture estimation model, so that the posture estimation model can learn the changes of actions of each key point on the human skeleton over time, and after model inference, obtain the position of each key point of the human skeleton of the user, improving the accuracy of the posture estimation model inference.

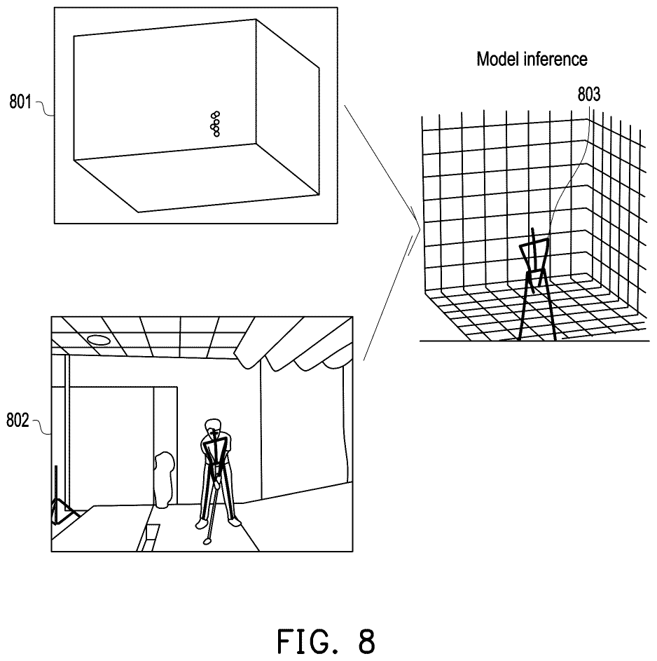

FIG. 8 is a schematic diagram of model inference according to an embodiment of the disclosure.

Referring to FIG. 8, in the model inference stage, that is, the actual posture estimation stage, point cloud information 801 and image information 802 after the aforementioned time synchronization processing may be input into the pre-trained posture estimation model. The posture estimation model is utilized to infer and obtain a position of each key point 803 of the human skeleton of the user, thereby obtaining the human posture.

In summary, in the posture estimation system and the method of the disclosure, the five-dimensional point cloud information obtained by the millimeter wave radar may compensate for the 2D image information captured by the camera in low-light environments or occlusion situations. Also, through synchronizing the point cloud information with the image information and using the LSTM and Transformer model, spatial and temporal relationships of the respective key points are obtained. Then, the posture estimation model is utilized to infer and obtain the position of each key point of the human skeleton of the user, thereby improving the accuracy of posture estimation.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A posture estimation system, comprising:
a millimeter wave radar configured to obtain point cloud information including a user;
a camera configured to capture images of a physical scene to obtain image information including the user; and
a processing device connected to the millimeter wave radar and the camera, and configured to:
obtain the point cloud information and the image information from the millimeter wave radar and the camera respectively;
perform point cloud information pre-processing on the point cloud information;
perform image information pre-processing on the image information; and
obtain a position of each key point of a human skeleton of the user through a posture estimation model.

2. The posture estimation system as claimed in claim 1, wherein after the processing device obtains the point cloud information and the image information from the millimeter wave radar and the camera respectively, the processing device is further configured to:
perform time alignment on the point cloud information and the image information.

3. The posture estimation system as claimed in claim 2, wherein in an operation of performing time alignment on the point cloud information and the image information, the processing device is further configured to:
obtain current point cloud information and current image information at a current time point;
if the current point cloud information at the current time point is lost, then use historical point cloud information at a closest time point adjacent to the current time point to serve as the current point cloud information.

4. The posture estimation system as claimed in claim 2, wherein in an operation of performing time alignment on the point cloud information and the image information, the processing device is further configured to:
obtain current point cloud information and current image information at a current time point;
if the current point cloud information at the current time point is lost, then average point cloud information at a previous time point adjacent to the current time point and point cloud information at a next time point adjacent to the current time point to serve as the current point cloud information.

5. The posture estimation system as claimed in claim 2, wherein in an operation of performing the point cloud information pre-processing on the point cloud information, the processing device is further configured to:
perform matrix conversion on the point cloud information to obtain a point cloud matrix;
obtain spatial feature information based on convolutional neural network (CNN) and the point cloud matrix; and
obtain temporal feature information based on the spatial feature information and Long Short-Term Memory (LSTM).

6. The posture estimation system as claimed in claim 5, wherein in an operation of performing the image information pre-processing on the image information, the processing device is further configured to:
perform human detection on the image information based on a human detection model and crop a human region including the user;
use a skeleton estimation model to identify each of the key points of the human skeleton of the user in the human region, and obtain coordinate information of each of the key points; and
obtain feature vectors of each of the key points at each time point according to the coordinate information of each of the key points and using a Transformer model.

7. The posture estimation system as claimed in claim 6, wherein the processing device is further configured to:
perform feature fusion based on the spatial feature information, the temporal feature information, and the feature vectors of each of the key points at each of the time points to establish the posture estimation model, and obtain the position of each of the key points of the human skeleton of the user through the posture estimation model.

8. A posture estimation method, comprising:
obtaining point cloud information including a user by a millimeter wave radar;
capturing images of a physical scene by a camera to obtain image information including the user;
obtaining the point cloud information and the image information from the millimeter wave radar and the camera respectively;
performing point cloud information pre-processing on the point cloud information;
performing image information pre-processing on the image information; and
obtaining a position of each key point of a human skeleton of the user through a posture estimation model.

9. The posture estimation method as claimed in claim 8, wherein after obtaining the point cloud information and the image information from the millimeter wave radar and the camera respectively, the method further comprises:
performing time alignment on the point cloud information and the image information.

10. The posture estimation method as claimed in claim 9, wherein a step of performing time alignment on the point cloud information and the image information further comprises:
obtaining current point cloud information and current image information at a current time point;
if the current point cloud information at the current time point is lost, then using historical point cloud information at a closest time point adjacent to the current time point to serve as the current point cloud information.

11. The posture estimation method as claimed in claim 9, wherein a step of performing time alignment on the point cloud information and the image information further comprises:
obtaining current point cloud information and current image information at a current time point;
if the current point cloud information at the current time point is lost, then averaging point cloud information at a previous time point adjacent to the current time point and point cloud information at a next time point adjacent to the current time point to serve as the current point cloud information.

12. The posture estimation method as claimed in claim 9, wherein a step of performing point cloud information pre-processing on the point cloud information further comprises:
performing matrix conversion on the point cloud information to obtain a point cloud matrix;
obtaining spatial feature information based on convolutional neural network (CNN) and the point cloud matrix; and
obtaining temporal feature information based on the spatial feature information and Long Short-Term Memory (LSTM).

13. The posture estimation method as claimed in claim 12, wherein a step of performing the image information pre-processing on the image information further comprises:
performing human detection on the image information based on a human detection model and cropping a human region including the user;
using a skeleton estimation model to identify each of the key points of the human skeleton of the user in the human region, and obtaining coordinate information of each of the key points; and
obtaining feature vectors of each of the key points at each time point according to the coordinate information of each of the key points and using a Transformer model.

14. The posture estimation method as claimed in claim 13, wherein the method further comprises:
performing feature fusion based on the spatial feature information, the temporal feature information, and the feature vectors of each of the key points at each of the time points to establish the posture estimation model, and obtaining the position of each of the key points of the human skeleton of the user through the posture estimation model.
